(19) United States
(12) Patent Application Publication
(10) Pub. No.: US 2014/0136523 A1
(43) Pub. Date: May 15, 2014

(54) Method, Apparatus And System For Providing Search Prompt Information Based On Session

(71) Applicant: TENCENT TECHNOLOGY (SHENZHEN) COMPANY LIMITED, SHENZHEN (CN)

(72) Inventors: Dengke YAO, Shenzhen (CN); Zhanliang LIU, Shenzhen (CN); Peipei ZHANG, Shenzhen (CN); Xu MENG, Shenzhen (CN); Hui XIAO, Shenzhen (CN); Ling XIE, Shenzhen (CN)

(73) Assignee: TENCENT TECHNOLOGY (SHENZHEN) COMPANY LIMITED, SHENZHEN (CN)

(21) Appl. No.: 14/160,082

(22) Filed: Jan. 21, 2014

Related U.S. Application Data
(63) Continuation of application No. PCT/CN2012/077286, filed on Jul. 21, 2012.

(30) Foreign Application Priority Data
Jul. 21, 2011 (CN) 201110205122.0

(51) Int. Cl. G06F 17/30

(52) U.S. Cl. CPC G06F 17/30657
USPC 707/722; 707/758

(57) ABSTRACT

A method, apparatus and system for providing search prompt information based on a session. The method is implemented as follows. A hot word list and a session message are obtained, and a word is selected from the session message according to a preset word selecting policy. The selected word is matched with the hot word list, and a word matching the hot word list is taken as a search prompt word, and search link information is set for the search prompt word. The search prompt word is marked.

### CROSS-REFERENCE TO RELATED APPLICATIONS

This application is a continuation of International Application No. PCT/CN2012/077286, filed on Jun. 21, 2012. This application claims the benefit and priority of Chinese Patent Application No. 201110205122.0, filed Jul. 21, 2011. The entire disclosures of each of the above applications are incorporated herein by reference.

### FIELD

The present disclosure relates to computer technologies and to a method, apparatus and system for providing search prompt information based on a session.

### BACKGROUND

This section provides background information related to the present disclosure which is not necessarily prior art.

With the development of computer communication technologies and Internet technologies, more and more users would like to perform a search on the Internet to obtain search information in their lives and work. A terminal device of a user is connected to a search server, such as a search engine or a search website server, through the Internet. If the user inputs a search keyword in a search window of a browser, the search server performs a search according to the search keyword and displays a search result to the user.

Since the use of the Internet has become more and more popular in people's lives, a hot word, as a reflection of network life, includes a hot word popular on the Internet and a keyword which is often searched for by users via the search engine. The hot word generally has universality and effectiveness during a period of time and may help users to learn relevant information quickly and timely. Through a browser, a user may see hot words provided by the search server. If the user is interested in a hot word, the user may click the hot word to trigger the search engine to perform a search and display a search result.

Currently, when performing a session via an Instant Messaging (IM) tool, the user may find interesting or puzzling contents. In this case, the user may move a mouse to select a keyword for the contents, and input the selected keyword in a newly-opened search window to perform a search. If the user wants to find a hot word corresponding to the interesting or puzzling contents, the user may see hot words provided by the search engine to find a hot word matching the interesting or puzzling contents, and may perform a search to obtain relevant search information.

As can be seen from the foregoing method for obtaining a search result based on a session, the user needs to select a search keyword manually and needs to open a new search window for the search if the user finds interesting or puzzling contents during the session performed via an IM tool. Besides, hot words provided by each website server are common, but are not individualized and are not combined with a current session environment of the user. As a result, the user needs to select a matched hot word manually, which makes an operation complicated, makes search efficiency lower and brings worse user experiences.

### SUMMARY

This section provides a general summary of the disclosure, and is not a comprehensive disclosure of its full scope or all of its features.

Various embodiments provide a method, system and apparatus for providing search prompt information based on a session, which may reduce operation complexity and increase search efficiency when a user performs a search.

The solution of the present disclosure is implemented as follows.

A method for providing search prompt information based on a session includes:
obtaining a hot word list;
obtaining a session message, selecting a word from the session message according to a preset word selecting policy, and matching the selected word with the hot word list; and
taking a word matching the hot word list as a search prompt word, setting search link information for the search prompt word, and marking the search prompt word.

An apparatus for providing search prompt information based on a session includes a hot word list obtaining module, a word selecting and matching module and a word marking module, wherein
the hot word list obtaining module obtains and stores a hot word list;
the word selecting and matching module obtains a session message, selects a word from the obtained session message according to a preset word selecting policy, and matches the selected word with the hot word list; and
the word marking module takes a word matching the hot word list as a search prompt word, sets search link information for the search prompt word, and marks the search prompt word.

A system for providing search prompt information based on a session includes an Instant Messaging (IM) client and a hot word list server, wherein
the IM client obtains a hot word list from the hot word list server, stores the hot word list, obtains a session message, selects a word from the obtained session message according to a preset word selecting policy, matches the selected word with the hot word list, takes a word matching the hot word list as a search prompt word, sets search link information for the search prompt word, and marks the search prompt word; and
the hot word list server obtains at least one hot word from an external search server to generate the hot word list including the at least one hot word, and sends the hot word list to the IM client.

A system for providing search prompt information based on a session includes an Instant Messaging (IM) client and a hot word list server, wherein
the IM client obtains a session message, sends the session message to the hot word list server, and receives the session message in which a search prompt word is marked from the hot word list server; and
the hot word list server obtains at least one hot word from an external search server to generate and store the hot word list including the at least one hot word, selects a word from the received session message according to a preset word selecting policy, matches the selected word with the hot word list, takes a word matching the hot word list as the search prompt word, sets search link information for the search prompt word, marks the search prompt word, and returns the session message in which the search prompt word is marked to the IM client.

As can be seen from the foregoing solution, the user does not need to open a new search window and manually input a search keyword for a search, which reduces operation complexity when the user performs the search and increases search efficiency. In addition, through matching the selected word with the hot word list that may be updated in real time, it is possible to recognize an input intention of the user based on a combination of the hot word list with a current session environment of the user. Further, it is also possible to assist the user in the search, automatically discover a search requirement of the user at any time, select a hot search prompt word to facilitate the user to trigger the search, and improve user experience.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

Various embodiments will be described hereinafter with reference to accompanying drawings so that one skilled in the art may understand the foregoing and other features and merits of the present disclosure more clearly.

FIG. 1 is a flowchart illustrating a method for providing search prompt information based on a session in accordance with various embodiments.

FIG. 2 is a flowchart illustrating a method for storing a hot word list and performing a word selecting policy by an IM client in accordance with various embodiments.

FIG. 3 is a flowchart illustrating a method for storing a hot word list and performing a word selecting policy by a hot word list server in accordance with various embodiments.

FIG. 4 is a schematic diagram illustrating an interface of a chat record in a chat window in accordance with various embodiments.

FIG. 5 is a diagram illustrating an interface for providing search prompt information in a chat window in accordance with various embodiments.

FIG. 6 is a diagram illustrating an interface displaying both search prompt information and a search result in accordance with various embodiments.

FIG. 7 is a block diagram illustrating the structure of an apparatus for providing search prompt information based on a session in accordance with various embodiments.

FIG. 8 is a block diagram illustrating the structure of a system for providing search prompt information based on a session in accordance with various embodiments.

Corresponding reference numerals indicate corresponding parts throughout the several views of the drawings.

### DETAILED DESCRIPTION

Example embodiments will now be described more fully with reference to the accompanying drawings.

Reference throughout this specification to “one embodiment,” “an embodiment,” “specific embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in a specific embodiment,” or the like in the singular or plural in various places throughout this specification are not necessarily all referring to the same embodiment. Furthermore, the particular features, structures, or characteristics may be combined in any suitable manner in one or more embodiments.

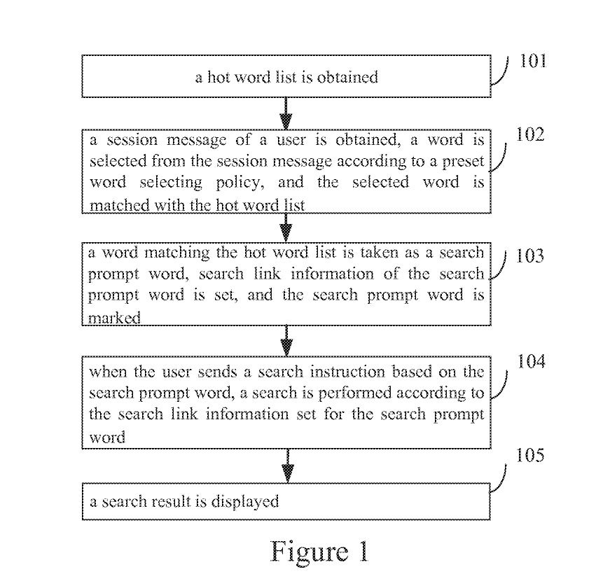

FIG. 1 is a flowchart illustrating a method for providing search prompt information based on a session in accordance with various embodiments. As shown in FIG. 1, the method includes the following blocks.

In block 101, a hot word list is obtained. The hot word list may be obtained by the various modes. A hot word list server obtains at least one hot word provided by a search server, and generates and stores the hot word list including the at least one hot word. Alternatively, the hot word list server obtains at least one hot word provided by the search server, generates the hot word list including the at least one hot word, and sends the hot word list to an IM client. Both the IM client and the hot word list server store the hot word list.

A hot word in the hot word list contains search link information for searching for the hot word. For example, in a hot word list that is generated based on hot words provided by the search server for a chat-while-search website of an IM client “QQ”, search link information of a hot word “CDMA” is a Uniform Resource Locator (URL) of a search engine of the chat-while-search website of the IM client “QQ”.

In various applications, the hot word list server may obtain, according to a preset update period, the latest hot words provided by the search server, thereby timely updating the hot word list.

In block 102, a session message of a user is obtained, a word is selected from the session message according to a preset word selecting policy, and the selected word is matched with the hot word list. If the hot word list is stored only in the hot word list server, the word selecting policy is set only in the hot word list server. The IM client sends the session message of the user to the hot word list server. The hot word list server selects the word from the session message according to the word selecting policy. The selected word is a part of the session message, and is matched with the hot word list. Relevant contents of the word selecting policy may refer to conventional technique documents and is not described herein.

If the hot word list is stored in both the hot word list server and the IM client, the word selecting policy is set in the IM client. The IM client selects the word from the session message of the user according to the word selecting policy, and matches the selected word with the hot word list.

In block 102, through matching the word selected from the session message with the hot word list, the user may learn which word in the session message is relatively hot and may be provided as hot information.

In block 103, a word matching the hot word list is taken as a search prompt word, search link information of the search prompt word is set, and the search prompt word is marked. In block 103, the word matching the hot word list is taken as the search prompt word, and the search link information of the search prompt word is set. The search link information of the search prompt word is search link information of a matched hot word in the hot word list, and is provided to the user. In this way, the user may trigger an automatic search and obtain a search result when operating the search prompt word. For example, suppose a chat-while-search function of IM client “QQ” is used to perform the search and the search prompt word is “CDMA”, the search link information is a URL of the search engine of the chat-while-search website of the IM client “QQ”, i.e.,

http://www.soso.com/q?sp=S&sc=web&cid.w.q.in.sb.web&ch.w.q.in.sb.w eb&ty=1&bn=&op=entry&kw=&source=&w=CDMA.

The search prompt word may be marked in the original session message. Thus, the user does not need to open a new search window or manually input a search keyword for the search, which reduces operation complexity when the user performs the search, assists the user in the search, and reduces the search cost of the user. Furthermore, through matching the selected word with the hot word list that may be updated in real time, it is possible to recognize an input intention of the user based on a combination of the hot word list with a current session environment of the user, and it is also possible to automatically discover a search requirement of the user and select a valuable and interesting search prompt word, thereby providing convenience and benefit to the user.

When the user clicks a search prompt word, a search window of a search engine is automatically linked to perform a search, and a search result is displayed to the user. When the user performs a session via the IM tool, a valuable word may be automatically selected according to current hot words in the hot word list and contents of the session, and the search prompt information may be provided. Thereby, the method may further include following blocks.

In block 104, when the user sends a search instruction based on the search prompt word, a search is performed according to the search link information set for the search prompt word. In block 104, based on the search prompt word marked in the session message, the user may click the search prompt word if the user wants to learn more relevant information of the search prompt word. The search may thus be performed automatically according to the search link information set for the search prompt word. The search requirement of the user may be discovered automatically, and the user does not need to consider how to perform the search but is directly provided with a simple search entrance, thereby reducing the search cost of the user, a time duration of the user for the search, and the operation complexity for the user.

In block 105, a search result is displayed.

A method for storing the hot word list by the IM client and a method for storing the hot word list by both the IM client and the hot word list server is described respectively hereinafter.

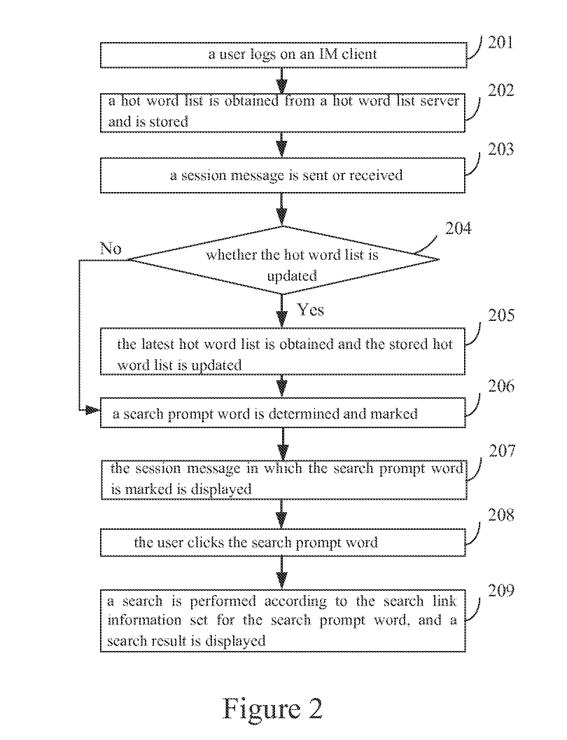

FIG. 2 is a flowchart illustrating a method for storing a hot word list and performing a word selecting policy by an IM client in accordance with various embodiments. As shown in FIG. 2, the method includes the following blocks.

In block 201, a user logs on an IM client.

In block 202, a hot word list is obtained from a hot word list server and is stored.

After the user logs on the IM client, the IM client automatically sends a hot word list obtaining request to the hot word list server and downloads the latest hot word list.

In block 203, a session message is sent or received. In block 203, the user chats via the IM client, sends a session message or receives a session message sent by the other session party.

In block 204, the hot word list server is queried to determine whether the hot word list is updated. If the hot word list is updated, block 205 is performed. In block 204, when the user sends a session message or receives a session message sent by the other session party, the user queries the hot word list server to determine whether the hot word list is updated, so as to obtain the latest hot word list. For example, the user may query the hot word list server to determine according to timestamp information of the hot word list whether the hot word list is updated. In practical applications, the user may not obtain the hot word list from the hot word list server immediately once the user logs on the IM client, but instead, may download the hot word list from the hot word list server when sending or receives a session message.

In block 205, the latest hot word list is obtained and the stored hot word list is updated.

In block 206, a search prompt word is determined and marked. In block 206, according to a word selecting policy, a word is selected from the session message sent or received in block 203. The selected word is matched with the hot word list obtained in block 205, and a word matching the hot word list is taken as the search prompt word. Search link information is set for the search prompt word and the search prompt word is marked.

In block 207, the session message in which the search prompt word is marked is displayed. In block 207, the session message in which the search prompt word is marked is displayed in a session displaying region of the IM client. For example, the search prompt word may be marked by an underline.

In block 208, the user clicks the search prompt word. In block 208, based on the search prompt word marked in the session message, the user may click the search prompt word if the user wants to learn more relevant information of the search prompt word.

In block 209, a search is performed according to the search link information set for the search prompt word, and a search result is displayed. In block 209, a search engine corresponding to the search link information set for the search prompt word is triggered to perform the search. After the search result is obtained, the search result is displayed in a preset mode. For example, a current interface is divided into columns and the search result is displayed at one side of a session column.

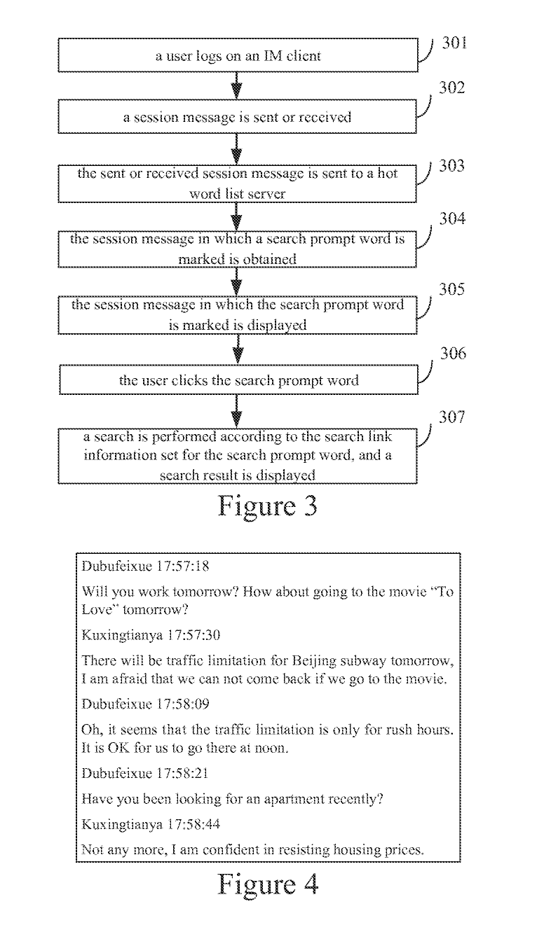

FIG. 3 is a flowchart illustrating a method for storing a hot word list and performing a word selecting policy by a hot word list server in accordance with various embodiments. As shown in FIG. 3, the method includes the following blocks.

In block 301, a user logs on an IM client.

In block 302, a session message is sent or received.

In block 303, the sent or received session message is sent to a hot word list server. In block 303, it may be set in advance that the sent or received session message is automatically sent to the hot word list server while the session message is sent to the other session party or the session message is received from the other session party. Thus, after the user logs on the IM client, the IM client may send the session message to the hot word list server when the user sends the session message to the other session party or receives the session message from the other session party.

In block 304, the session message in which a search prompt word is marked is obtained. In block 304, according to the latest hot word list stored by the hot word list server and the session message sent by the IM client, the hot word list server selects a word from the session message according to a word selecting policy and matches the selected word with the hot word list. The hot word list server then takes a word matching the hot word list as the search prompt word, sets search link information for the search prompt word, marks the search prompt word, and returns the session message in which the search prompt word is marked to the IM client.

In practical applications, the hot word list server may periodically obtain hot words from a search server to generate the hot word list. Thus, after the search server updates the hot words, the hot word list server may obtain the latest hot words in time.

In block 305, the session message in which the search prompt word is marked is displayed.

In block 306, the user clicks the search prompt word.

In block 307, a search is performed according to the search link information set for the search prompt word, and a search result is displayed. In block 307, the search link information set for the search prompt word is linked to a search engine corresponding to the search link information to perform the search, and the obtained search result is displayed.

As can be seen from the foregoing, in the method for performing the word selecting policy by the IM client, the IM client does not need to send the session message to the hot word list server, but only needs to request the hot word list server for the latest hot word list. Thus, the word selecting policy generally cannot be updated. In the method for performing the word selecting policy by the hot word list server, the IM client does not need to download the latest hot word list from the hot word list server, and thus an update to the word selecting policy may become effective in time.

A method for providing search prompt information is described hereinafter by various embodiments that an IM tool installed at the IM client is an IM tool “QQ”. During a chat of a user, the IM tool “QQ” may give the user a prompt of a hot search prompt word in real time according to contents of a session of the user. The search prompt word is displayed with an underline and a link. When the user moves a mouse in an arrow shape to the search prompt word marked with the underline, the shape of the mouse is changed to a hand shape so as to prompt the user that the user may perform a search directly via the search prompt word, and the user clicks the search prompt word to trigger the search.

FIG. 4 is a diagram illustrating an interface of a chat record in a chat window in accordance with various embodiments. As shown in FIG. 4, the chat record in the chat window is described as follows.
Dubufeixue 17:57:18
Will you work tomorrow? How about going to the movie “To Love” tomorrow?
Kuxingtianya 17:57:30
There will be traffic limitation for Beijing subway tomorrow, I am afraid that we can not come back if we go to the movie.
Dubufeixue 17:58:09
Oh, it seems that the traffic limitation is only for rush hours. It is OK for us to go there at noon.
Dubufeixue 17:58:21
Have you been looking for an apartment recently?
Kuxingtianya 17:58:44
Not any more, I am confident in resisting housing prices.

It is supposed that the hot word list server stores the hot word list and performs the word selecting policy. The IM client sends the session message to the hot word list server according to a preset policy. For example, the preset policy may be as follows. When the user sends a session message to the other session party or receives a session message from the other session party, the user sends the sent or received session message to the hot word list server. Alternatively, in practical applications, the preset policy may be as follows. After the user sends and/or receives a predetermined number of session messages, the user sends the predetermined number of session messages to the hot word list server.

The hot word list server receives the session message, selects, according to the preset word selecting policy, a search prompt word matching the hot word list from the received session message, marks the search prompt word with an underline, sets search link information of a search engine corresponding to the search prompt word, and returns the session message in which the search prompt word is marked to the IM client.

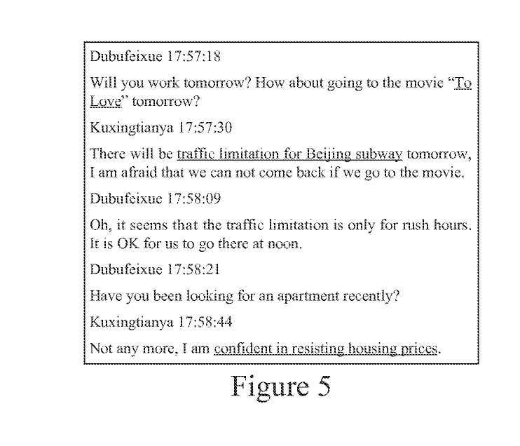

The IM client receives the session message in which the search prompt word is marked from the hot word list server, matches the received session message with the chat record in the chat window that has been sent to the hot word list server, and replaces an original session message in the chat window by the session message in which the search prompt word is marked, as shown in FIG. 5. FIG. 5 is a diagram illustrating an interface for providing search prompt information in a chat window in accordance with various embodiments. As shown in FIG. 5, the chat record in the chat window is described as follows.
Dubufeixue 17:57:18
Will you work tomorrow? How about going to the movie “To Love” tomorrow?
Kuxingtianya 17:57:30
There will be traffic limitation for Beijing subway tomorrow, I am afraid that we can not come back if we go to the movie.
Dubufeixue 17:58:09
Oh, It seems that the traffic limitation is only for rush hours. It is OK for us to go there at noon.
Dubufeixue 17:58:21
Have you been looking for an apartment recently?
Kuxingtianya 17:58:44
Not any more, I am confident in resisting housing prices.

If the user is interested in “traffic limitation for Beijing subway” and needs to perform a further search to learn relevant information, the user may click the marked “traffic limitation for Beijing subway” to trigger a search engine corresponding to the search link information to perform a search by the keyword “traffic limitation for Beijing subway”. A search result is displayed to the user in different columns. Alternatively, the search result may be displayed to the user in other modes, for example, in a new window.

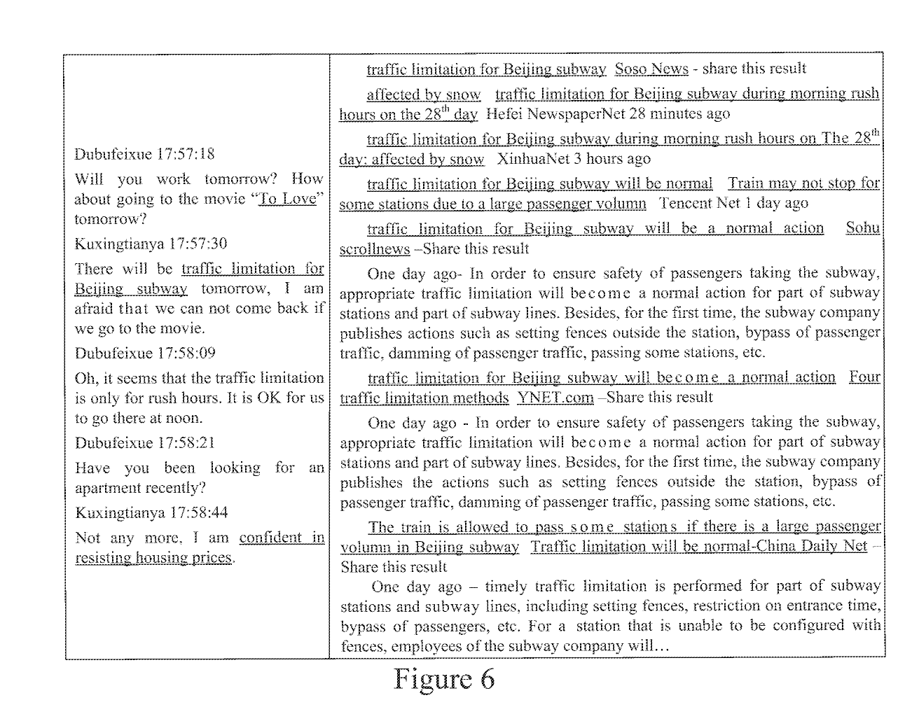

FIG. 6 is a diagram illustrating an interface displaying both search prompt information and a search result in accordance with various embodiments. As shown in FIG. 6, the current window interface is divided into two columns based on the interface shown in FIG. 5. The left column displays the marked chat record, and the right column displays the search result. Taking the search with the keyword “traffic limitation for Beijing subway” as an example, the search result is described as follows.
traffic limitation for Beijing subway Soso News—share this result
affected by snow traffic limitation for Beijing subway during morning rush hours on the 28^{th} day Hefei NewspaperNet 28 minutes ago
traffic limitation for Beijing subway during morning rush hours on the 28^{th} day: affected by snow XinhuaNet 3 hours ago
traffic limitation for Beijing subway will become normal Train may pass some stations due to a large passenger volume Tencent 1 day ago
traffic limitation for Beijing subway will become a normal action Sohu scrollnews—Share this result
One day ago—In order to ensure safety of passengers taking the subway, appropriate traffic limitation will become a normal action for part of subway stations and part of subway lines. Besides, for the first time, the subway company publishes actions such as setting fences outside a subway station, bypass of passenger traffics, damming of passenger traffics, passing some stations, etc.
traffic limitation for Beijing subway will become a normal action Four traffic limitation methods YNET.com—Share this result
One day ago—In order to ensure safety of passengers taking the subway, appropriate traffic limitation will become a normal action for part of subway stations and part of subway lines. Besides, for the first time, the subway company publishes the actions such as setting fences outside the station, bypass of passenger traffic, damming of passenger traffic, passing some stations, etc.
The train is allowed to pass some stations if there is a large passenger volume in Beijing subway Traffic limitation will be normal-China Daily—Share this result
One day ago—appropriate traffic limitation is performed for part of subway stations and subway lines, including setting fences, restriction on entrance time, bypass of passengers, etc. For a station that is unable to be configured with fences, employees of the subway company will.

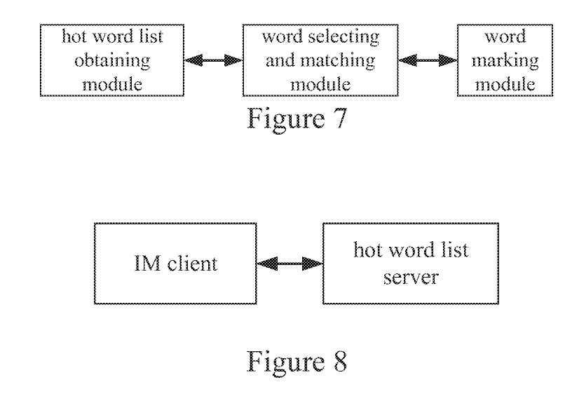

FIG. 7 is a block diagram illustrating the structure of an apparatus for providing search prompt information based on a session in accordance with various embodiments. As shown in FIG. 7, the apparatus may be a hot word list server or an IM client. The apparatus includes a hot word list obtaining module, a word selecting and matching module and a word marking module.

The hot word list obtaining module obtains and stores a hot word list.

In various embodiments, a hot word in a search server contains search link information for searching for the hot word. Thereby, in the hot word list, each hot word contains search link information.

The word selecting and matching module obtains a session message, selects a word from the obtained session message according to a preset word selecting policy, and matches the selected word with the hot word list.

In various embodiments, contents of the session message which match the hot word list are selected from the session message according to the hot word list and the word selecting policy.

The word marking module takes a word matching the hot word list as a search prompt word, sets search link information for the search prompt word, and marks the search prompt word.

In various embodiments, search link information is set for the search prompt word according to search link information of the matched hot word in the hot word list, and the search prompt word is marked by an underline.

If the apparatus shown in FIG. 7 is the IM client, the apparatus may further include a searching module and a search result displaying module (not shown in the figure).

The searching module performs a search based on the search prompt word selected by a user and according to the search link information set for the search prompt word, and outputs a search result to the search result displaying module.

The search result displaying module displays the search result.

In various embodiments, the search result may be displayed according to predefined settings. For example, the current interface may be divided into columns and the search result may be displayed at one side of a session column.

FIG. 8 is a block diagram illustrating the structure of a system for providing search prompt information based on a session in accordance with various embodiments. As shown in FIG. 8, the system includes an IM client and a hot word list server.

The IM client obtains a hot word list from the hot word list server, stores the hot word list, obtains a session message, selects a word from the obtained session message according to a preset word selecting policy, matches the selected word with the hot word list, takes a word matching the hot word list as a search prompt word, sets search link information for the search prompt word, and marks the search prompt word.

The hot word list server obtains at least one hot word from an external search server to generate the hot word list including the at least one hot word, and sends the hot word list to the IM client.

Alternatively, the IM client obtains the session message, sends the session message to the hot word list server, and receives the session message in which the search prompt word is marked from the hot word list server.

The hot word list server obtains at least one hot word from the external search server to generate and store the hot word list including the at least one hot word, selects the word from the received session message according to the preset word selecting policy, matches the selected word with the hot word list, takes a word matching the hot word list as the search prompt word, sets the search link information for the search prompt word, marks the search prompt word, and returns the session message in which the search prompt word is marked to the IM client.

A working procedure of the apparatus shown in FIG. 7 or the apparatus shown in FIG. 8 may be referred to the above method embodiments, and are not described herein.

The methods and modules described herein may be implemented by hardware, machine-readable instructions or a combination of hardware and machine-readable instructions. Machine-readable instructions used in the embodiments disclosed herein may be stored in storage medium readable by multiple processors, such as hard drive, CD-ROM, DVD, compact disk, floppy disk, magnetic tape drive, RAM, ROM or other proper storage device. Or, at least part of the machine-readable instructions may be substituted by specific-purpose hardware, such as custom integrated circuits, gate array, FPGA, PLD and specific-purpose computers, and so on.

A machine-readable storage medium is also provided, which stores instructions to cause a machine to execute a method as described herein. Specifically, a system or apparatus having a storage medium that stores machine-readable program codes for implementing functions of any of the above examples and that may make the system or the apparatus (or CPU or MPU) read and execute the program codes stored in the storage medium.

In this situation, the program codes read from the storage medium may implement any one of the above embodiments, thus the program codes and the storage medium storing the program codes are part of the technical scheme.

The storage medium for providing the program codes may include floppy disk, hard drive, magneto-optical disk, compact disk (such as CD-ROM, CD-R, CD-RW, DVD-ROM, DVD-RAM, DVD-RW, DVD+RW), magnetic tape drive, Flash card, ROM, and so on. Optionally, the program code may be downloaded from a server computer via a communication network.

It should be noted that, alternatively to the program codes being executed by a computer, at least part of the operations performed by the program codes may be implemented by an operation system running in a computer following instructions based on the program codes to realize a technical scheme of any of the above embodiments.

In addition, the program codes implemented from a storage medium are written in a storage in an extension board inserted in the computer or in a storage in an extension unit connected to the computer. In this embodiment, a CPU in the extension board or the extension unit executes at least part of the operations according to the instructions based on the program codes to realize a technical scheme of any of the above embodiments.

The foregoing is only embodiments of the present disclosure. The protection scope of the present disclosure, however, is not limited to the above description. Any change or substitution, easily occurring to one skilled in the art, should be covered by the protection scope of the present disclosure.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method for providing search prompt information based on a session, comprising:
obtaining a hot word list;
obtaining a session message, selecting a word from the session message according to a preset word selecting policy, and matching the selected word with the hot word list; and
taking a word matching the hot word list as a search prompt word, setting search link information for the search prompt word, and marking the search prompt word.

2. The method of claim 1, after marking the search prompt word, further comprising:
when an Instant Messaging (IM) client determines that a user sends a search instruction based on the search prompt word, making a search according to the search link information set for the search prompt word, and displaying a search result.

3. The method of claim 1, wherein the obtaining the hot word list comprises:
obtaining, by a hot word list server, at least one hot word provided by a search server, generating the hot word list including the at least one hot word, and sending the hot word list to an IM client; and
receiving and storing, by the IM client, the hot word list;
the obtaining the session message, selecting the word from the session message according to the preset word selecting policy, matching the selected word with the hot word list, taking the word matching the hot word list as the search prompt word, setting the search link information for the search prompt word, and marking the search prompt word comprise:
sending or receiving, by the IM client, the session message, selecting the word from the sent or received session message according to the preset word selecting policy, matching the selected word with the hot word list; and
taking, by the IM client, the word matching the hot word list as the search prompt word, setting the search link information for the search prompt word, and marking the search prompt word.

4. The method of claim 3, after the IM client sends or receives the session message, further comprising:
querying, by the IM client, the hot word list server to determine whether the hot word list is updated;
if the hot word list is updated, obtaining, by the IM client, a latest hot word list, updating the stored hot word list, and selecting the word from the sent or received session message according to the preset word selecting policy; and
if the hot word list is not updated, selecting, by the IM client, the word from the sent or received session message according to the preset word selecting policy.

5. The method of claim 1, wherein the obtaining the hot word list comprises:
obtaining, by a hot word list server, at least one hot word provided by a search server, generating and storing the hot word list including the at least one hot word;
the obtaining the session message, selecting the word from the session message according to the preset word selecting policy, matching the selected word with the hot word list, taking the word matching the hot word list as the search prompt word, setting the search link information for the search prompt word, and marking the search prompt word comprise:
sending or receiving, by an IM client, the session message;
sending, by the IM client, the sent or received session message to the hot word list server;
selecting, by the hot word list server, the word from the received session message according to the preset word selecting policy, matching the selected word with the hot word list, taking the word matching the hot word list as the search prompt word, setting the search link information for the search prompt word, marking the search prompt word, and returning the session message in which the search prompt word is marked to the IM client.

6. The method of claim 2, wherein the search result and the session message are displayed in different columns of a same interface.

7. Apparatus for providing search prompt information based on a session, comprising a hot word list obtaining module, a word selecting and matching module and a word marking module, wherein
the hot word list obtaining module obtains and stores a hot word list;
the word selecting and matching module obtains a session message, selects a word from the obtained session message according to a preset word selecting policy, and matches the selected word with the hot word list; and
the word marking module takes a word matching the hot word list as a search prompt word, sets search link information for the search prompt word, and marks the search prompt word.

8. The apparatus of claim 7, wherein the apparatus is an Instant Messaging (IM) client or a hot word list server.

9. A system for providing search prompt information based on a session, comprising an Instant Messaging (IM) client and a hot word list server, wherein
the IM client obtains a hot word list from the hot word list server, stores the hot word list, obtains a session message, selects a word from the obtained session message according to a preset word selecting policy, matches the selected word with the hot word list, takes a word matching the hot word list as a search prompt word, sets search link information for the search prompt word, and marks the search prompt word; and
the hot word list server obtains at least one hot word from an external search server to generate the hot word list including the at least one hot word, and sends the hot word list to the IM client.

10. A system for providing search prompt information based on a session, comprising an Instant Messaging (IM) client and a hot word list server, wherein
the IM client obtains a session message, sends the session message to the hot word list server, and receives the session message in which a search prompt word is marked from the hot word list server; and
the hot word list server obtains at least one hot word from an external search server to generate and store the hot word list including the at least one hot word, selects a word from the received session message according to a preset word selecting policy, matches the selected word with the hot word list, takes a word matching the hot word list as the search prompt word, sets search link information for the search prompt word, marks the search prompt word, and returns the session message in which the search prompt word is marked to the IM client.
